(19) United States
(12) Patent Application Publication
(10) Pub. No.: US 2026/0045200 A1
(43) Pub. Date: Feb. 12, 2026

(54) COMPOSITE DISPLAY CONTROLLING SYSTEM, COMPOSITE DISPLAY CONTROLLING METHOD AND COMPOSITE DISPLAY DEVICE

(71) Applicant: Iris Optronics Co., Ltd., Tainan City (TW)

(72) Inventors: Chung Yi CHANG, Tainan City (TW); Chi Chang LIAO, Tainan City (TW)

(21) Appl. No.: 19/186,670

(22) Filed: Apr. 23, 2025

(30) Foreign Application Priority Data
Aug. 8, 2024 (TW) 113129731

(51) Int. Cl. G09G 3/20; G02F 1/1347; G09G 3/36

(52) U.S. Cl. CPC G09G 3/2096; G09G 3/3607; G02F 1/13478; G09G 2320/0233; G09G 2320/0242; G09G 2320/066; G09G 2320/0666; G09G 2320/0693; G09G 2330/023

(57) ABSTRACT

A composite display controlling system is proposed, and includes a composite display device, a sensing module and a local controlling module. The composite display device includes a transflective display panel and an active display panel. The sensing module senses the environment surrounding the composite display device to generate environmental information. The local controlling module is connected to the composite display device and the sensing module, and compares the environmental information with an environmental judgment data to generate an environmental comparison result. The local controlling module generates a first control signal and a second control signal according to the environment comparison result, and controls the opening and closing of the trans-reflective display panel and the active display panel. The local controlling module adjusts the second control signal according to a transmission spectrum of the transflective display panel to calibrate the luminous intensity of the active display panel.

### RELATED APPLICATIONS

This application claims priority to Taiwan Application Serial Number 113129731, filed Aug. 8, 2024, which is herein incorporated by reference.

### BACKGROUND

### Technical Field

The present disclosure relates to a composite display controlling system, a composite display controlling method and a composite display device. More particularly, the present disclosure relates to a composite display controlling system, a composite display controlling method and a composite display device applied to a transflective display panel and an active display panel.

### Description of Related Art

In addition to including a planar state for controlling the reflectivity of the panel to reflect ambient light to provide an image, one of the characteristics of a transflective display panel, such as cholesteric liquid crystal display (ChLCD), further includes a focal conic state for allowing part of ambient light to penetrate to the bottom of the transflective display. By combining an active display panel, such as mini light emitting diode (mini LED) at the bottom of ChLCD, a new display can be formed. When the ambient light is sufficient, ChLCD is used as the main display. When the ambient light is insufficient, the active display panel is used as the main display. Although the new display can save power, it still has problems of color shift and poor image contrast that need to be solved. In addition, how to accurately control and switch the transflective display panel and the active display panel in response to environmental changes is also the key to practical application.

### SUMMARY

According to one aspect of the present disclosure, a composite display controlling system includes a composite display device, a sensing module and a local controlling module. The composite display device includes a transflective display panel and an active display panel. The active display panel is disposed opposite to the transflective display panel. The sensing module is configured to sense an environment surrounding the composite display device to generate an environmental information. The local controlling module is electrically connected to the composite display device and the sensing module, and compares the environmental information with an environmental judgment data to generate an environmental comparison result. The local controlling module generates a first control signal and a second control signal according to the environmental comparison result, and respectively controls an opening and closing of the transflective display panel and an opening and closing of the active display panel through the first control signal and the second control signal, so that the composite display device operates in a display mode. The local controlling module adjusts the second control signal according to a transmission spectrum of the transflective display panel to calibrate a luminous intensity of the active display panel operating in the display mode.

According to another aspect of the present disclosure, a composite display controlling method is configured to control a composite display device, and the composite display device includes a transflective display panel and an active display panel. The composite display control method includes sensing an environment surrounding the composite display device to generate an environmental information by a sensing module; comparing the environmental information with an environmental judgment data to generate an environmental comparison result and generating a first control signal and a second control signal according to the environmental comparison result by a local controlling module; and respectively controlling an opening and closing of the transflective display panel and an opening and closing of the active display panel through the first control signal and the second control signal by the local controlling module, so that the composite display device operates in a display mode. The local controlling module adjusts the second control signal according to a transmission spectrum of the transflective display panel to calibrate a luminous intensity of the active display panel operating in the display mode.

According to yet another aspect of the present disclosure, a composite display device is controlled by a local controlling module. The composite display device includes a transflective display panel and an active display panel. The transflective display panel receives a first control signal from the local controlling module, and an opening and closing of the transflective display panel is controlled by the first control signal. The active display panel is disposed opposite to the transflective display panel and receives a second control signal from the local controlling module, and an opening and closing of the active display panel is controlled by the second control signal. The composite display device operates in a display mode, and the second control signal is adjusted according to a transmission spectrum of the transflective display panel to calibrate a luminous intensity of the active display panel operating in the display mode.

### BRIEF DESCRIPTION OF THE DRAWINGS

The present disclosure can be more fully understood by reading the following detailed description of the embodiment, with reference made to the accompanying drawings as follows:

FIG. 1 shows a block diagram of a composite display controlling system according to a first embodiment of the present disclosure.

FIG. 2 shows a cross-sectional view of a transflective display panel of the composite display controlling system in FIG. 1.

FIG. 3 shows a schematic view of a transmission spectrum of a first adhesive layer and a second adhesive layer of the transflective display panel in FIG. 1.

FIG. 4 shows a flow chart of executing a white point calibration procedure in a composite display controlling method by the composite display controlling system of FIG. 1.

FIG. 5 shows a comparison schematic view of two luminous intensities of an active display panel in FIG. 1 before and after adjustment.

FIG. 6 shows a cross-sectional view of the active display panel of the composite display controlling system in FIG. 1.

FIG. 7 shows a schematic view of a transmission spectrum of a color optical adhesive layer of the composite display device in FIG. 1.

FIG. 8 shows a flow chart of a composite display controlling method according to a second embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected” to another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

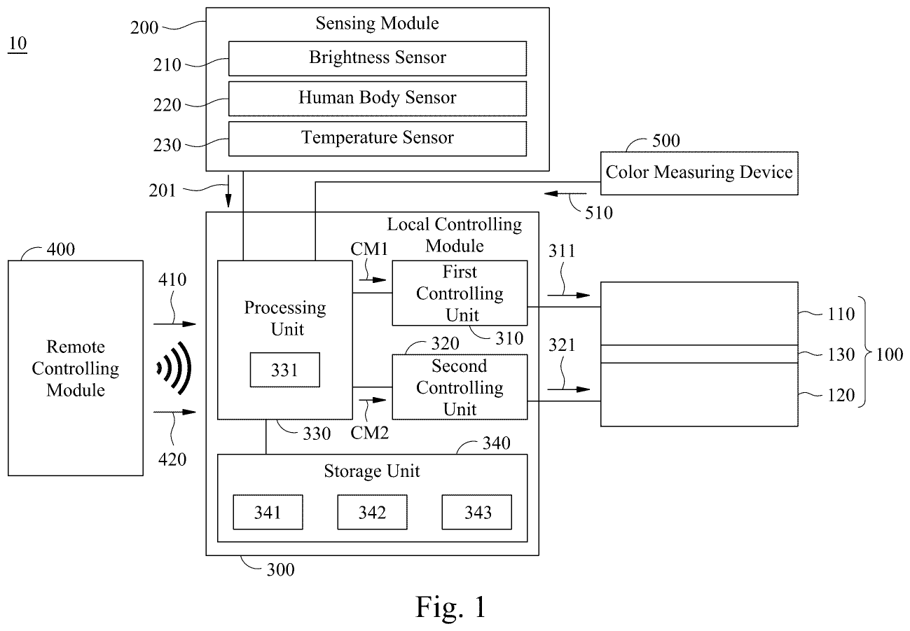

Please refer to FIG. 1. FIG. 1 shows a block diagram of a composite display controlling system according to a first embodiment of the present disclosure. As shown in FIG. 1, the composite display controlling system 10 includes a composite display device 100, a sensing module 200 and a local controlling module 300.

The composite display device 100 is controlled by the local controlling module 300, and includes a transflective display panel 110 and an active display panel 120. The active display panel 120 is disposed opposite to the bottom of the transflective display panel 110. The sensing module 200 is configured to sense an environment surrounding the composite display device 100 to generate an environmental information 201. The local controlling module 300 is electrically connected to the composite display device 100 and the sensing module 200, and compares the environmental information 201 with an environmental judgment data 341 to generate an environmental comparison result 331. The local controlling module 300 generates a first control signal 311 and a second control signal 321 according to the environmental comparison result 331, and respectively controls an opening and closing of the transflective display panel 110 and an opening and closing of the active display panel 120 through the first control signal 311 and the second control signal 321, so that the composite display device 100 operates in a display mode. In particular, the local controlling module 300 can also adjust the second control signal 321 according to a transmission spectrum 342 of the transflective display panel 110 to calibrate a luminous intensity of the active display panel 120 operating in the display mode.

Thus, the composite display controlling system 10 of the present disclosure can not only adjust the display mode in real time according to the environmental information 201 obtained by the sensing module 200 to realize the functions of intelligent energy saving and precision marketing, but also avoid the color shift problem caused by a second image of the active display panel 120 being filtered after passing through an optical clear adhesive inside the transflective display panel 110.

In detail, the local controlling module 300 includes a first controlling unit 310, a second controlling unit 320, a processing unit 330 and a storage unit 340. The first controlling unit 310 is configured to control the transflective display panel 110. The second controlling unit 320 is configured to control the active display panel 120. The processing unit 330 is electrically connected to the sensing module 200, the first controlling unit 310, the second controlling unit 320 and the storage unit 340. The storage unit 340 stores the environmental judgment data 341 and the transmission spectrum 342 of the transflective display panel 110. The processing unit 330 reads the environmental judgment data 341 from the storage unit 340 and receives the environmental information 201 from the sensing module 200, and compares the environmental information 201 with the environmental judgment data 341 to generate the environmental comparison result 331. The processing unit 330 generates a first control command CM1 and a second control command CM2 according to the environmental comparison result 331, and transmits the first control command CM1 to the first controlling unit 310 via a serial peripheral interface (SPI) and transmits the second control command CM2 to the second controlling unit 320 via a general-purpose input/output (GPIO).

In some embodiments, both of the first controlling unit 310 and the second controlling unit 320 can be, but are not limited to, a timing controller (TCON). The processing unit 330 can be, but is not limited to a processor, a microprocessor, a central processing unit (CPU), a computer, a mobile device processor, an advanced RISC machine (ARM) processor or other electronic processors. The storage unit 340 can be, but is not limited to a memory, a random access memory (RAM), a video random access memory (VRAM) or other types of dynamic storage devices that can store information and commands provided to the processing unit 330 for execution.

The composite display controlling system 10 can further a remote controlling module 400, and the remote controlling module 400 can include at least a cloud controller or an electronic processor that is the same as the processing unit 330 to execute data processing and computing. The remote controlling module 400 is signally connected to the processing unit 330 of the local controlling module 300. The processing unit 330 returns the environmental information 201 to the remote controlling module 400, so that the remote controlling module 400 transmits a control parameter 410 and a visual content data 420 to the local controlling module 300 according to the environmental information 201 received from the local controlling module 300 so as to utilize the control parameter 410 to update the environmental judgment data 341 stored in the storage unit 340. Specifically, the environmental judgment data 341 can include a brightness threshold, a frequency threshold and/or a frequency range, a temperature threshold and/or a temperature range. The control parameter 410 can include a plurality of parameter data for updating the brightness threshold, the frequency threshold and/or frequency range, the temperature threshold and/or temperature range in the environmental judgment data 341. The remote controlling module 400 can determine the control parameter 410 based on the environmental information 201 currently collected by the sensing module 200, and update the environmental judgment data 341 originally stored in the storage unit 340 through the control parameter 410. Moreover, the remote controlling module 400 can also determine the visual content data 420 based on the environmental information 201 currently collected by the sensing module 200, and update the preset visual content data originally stored in the storage unit 340 through the visual content data 420. For example, if the surrounding environment of the composite display device 100 has sufficient sunlight, the remote controlling module 400 can increase the brightness threshold; if the composite display device 100 is located in a crowded place, the remote controlling module 400 can increase the frequency threshold; if the composite display device 100 is in hot summer, the remote controlling module 400 can increase the temperature threshold. The local controlling module 300 controls the composite display device 100 to display an image mainly based on the preset visual content data. Therefore, before the remote controlling module 400 transmits the visual content data 420 for updating the preset visual content data, the local controlling module 300 controls the composite display device 100 to display a carousel image corresponding to the preset visual content data according to the environmental information 201 collected by the sensing module 200.

In addition, the processing unit 330 can transmit the first control command CM1 and the visual content data 420 to the first controlling unit 310 via SPI and low-voltage differential signaling (LVDS), respectively. The processing unit 330 can transmit the second control command CM2 and the visual content data 420 to the second control unit 320 via GPIO and high definition multimedia interface (HDMI), respectively. Therefore, the first controlling unit 310 of the local controlling module 300 can generate a first enable signal of the first control signal 311 according to the first control command CM1, and generate a first image data of the first control signal 311 according to the visual content data 420. The second controlling unit 320 of the local controlling module 300 can generate a second enable signal of the second control signal 321 according to the second control command CM2, and generate a second image data of the second control signal 321 according to the visual content data 420. Finally, the transflective display panel 110 receives the first control signal 311 from the local controlling module 300, and its own opening and closing are controlled by the first enable signal, and the transflective display panel 110 displays a first image based on the first image data. The active display panel 120 receives the second control signal 321 from the local controlling module 300, and its own opening and closing are controlled by the second enable signal, and the active display panel 120 displays a second image based on the second image data.

Furthermore, the sensing module 200 can include a brightness sensor 210, a human body sensor 220 and a temperature sensor 230. The brightness sensor 210 is configured to sense the environment surrounding the composite display device 100 to generate a brightness value of the environmental information 201. The human body sensor 220 is configured to sense the environment surrounding the composite display device 100 to generate a human body appearance frequency of the environmental information 201. The temperature sensor 230 is configured to sense the environment surrounding the composite display device 100 to generate a temperature value of the environmental information 201. It should be noted that the human body appearance frequency represents the number of times the human body sensor 220 recognizes a pedestrian passing by per unit time.

In some embodiments, in response to determine that the environmental comparison result 331 is that the brightness value is greater than or equal to the brightness threshold (e.g., 2000 Lux), the local controlling module 300 controls the transflective display panel 110 to be turned on through the first control signal 311 and controls the active display panel 120 to be turned off through the second control signal 321, so that the composite display device 100 operates in a reflective mode of the display mode; in response to determine that the environmental comparison result 331 is that the brightness value is less than the brightness threshold, the local controlling module 300 controls the transflective display panel 110 to be turned off through the first control signal 311 and controls the active display panel 120 to be turned on through the second control signal 321, so that the composite display device 100 operates in a transmission mode of the display mode. In the reflection mode, the cholesteric liquid crystal in the transflective display panel 110 is in a planar state and reflects ambient light to display the first image, thereby giving full play to the characteristics of high visibility, rich colors and power saving. In the transmission mode, the cholesteric liquid crystal in the transflective display panel 110 is in a focal conic state, so the second image displayed by the active display panel 120 can penetrate the transflective display panel 110 and project outward, thereby giving full play to the characteristics of high brightness, high contrast, wide color gamut and fast response speed.

In some embodiments, in response to determine that the environment comparison result 331 is that the human body appearance frequency is greater than or equal to the frequency threshold (for example, 10 pedestrians pass by every minute), the local controlling module 300 changes a first image refresh rate of the transflective display panel 110 to a first refresh rate (for example, updating the screen once every minute) through the first control signal 311, and changes a second image refresh rate of the active display panel 120 to the first refresh rate through the second control signal 321; in response to determine that the environment comparison result 331 is that the human body appearance frequency is less than the frequency threshold, the local controlling module 300 changes the first image refresh rate of the transflective display panel 110 to a second refresh rate (for example, updating the screen every 30 minutes) through the first control signal 311, and changes the second image refresh rate of the active display panel 120 to the second refresh rate through the second control signal 321. Specifically, the second refresh rate is less than the first refresh rate. The purpose is that if there are many people around the composite display device 100, the local controlling module 300 can increase the image refresh rate of each panel to attract attention. On the contrary, if there are few people around the composite display device 100, the local controlling module 300 can reduce the power consumption of each panel by reducing the image refresh rate of each panel.

In some embodiments, in response to determine that the environment comparison result 331 is that the temperature value is greater than or equal to the temperature threshold (e.g., 30 degrees Celsius), the local controlling module 300 controls the transflective display panel 110 to display the first image corresponding to a first visual content through the first control signal 311, and controls the active display panel 120 to display the second image corresponding to the first visual content through the second control signal 311; in response to determine that the environment comparison result 331 is that the temperature value is less than the temperature threshold, the local controlling module 300 controls the transflective display panel 110 to display the first image corresponding to a second visual content through the first control signal 311, and controls the active display panel 120 to display the second image corresponding to the second visual content through the second control signal 321. The second visual content is different from the first visual content. For example, if the temperature value of the environment surrounding the composite display device 100 is greater than the temperature threshold, the first visual content can be related to cooling and relieving heat. On the contrary, if the temperature value of the environment surrounding the composite display device 100 is less than the temperature threshold, the second visual content can be related visual content about having ample food and clothing. Thus, the composite display controlling system 10 of the present disclosure can analyze the environmental information 201 to determine the scheduling (i.e., mode switching and refresh rate changing) between the transflective display panel 110 and the active display panel 120 in the composite display device 100 and its displayed visual content, thereby achieving the functions of intelligent energy saving and precision marketing.

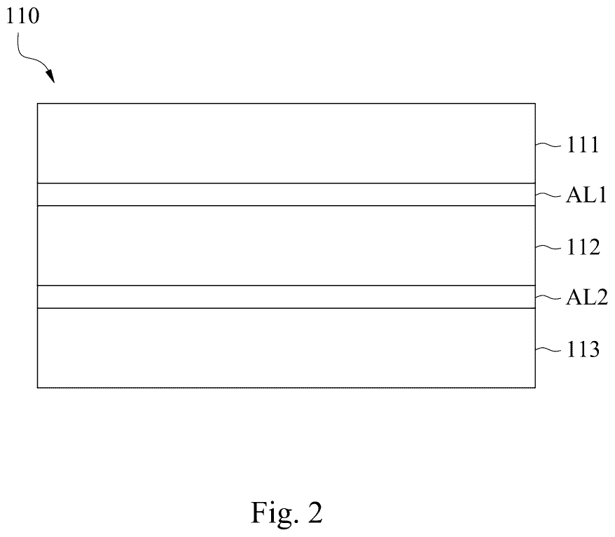

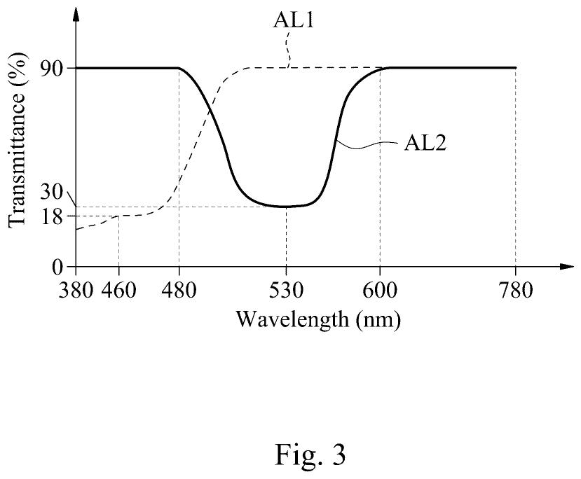

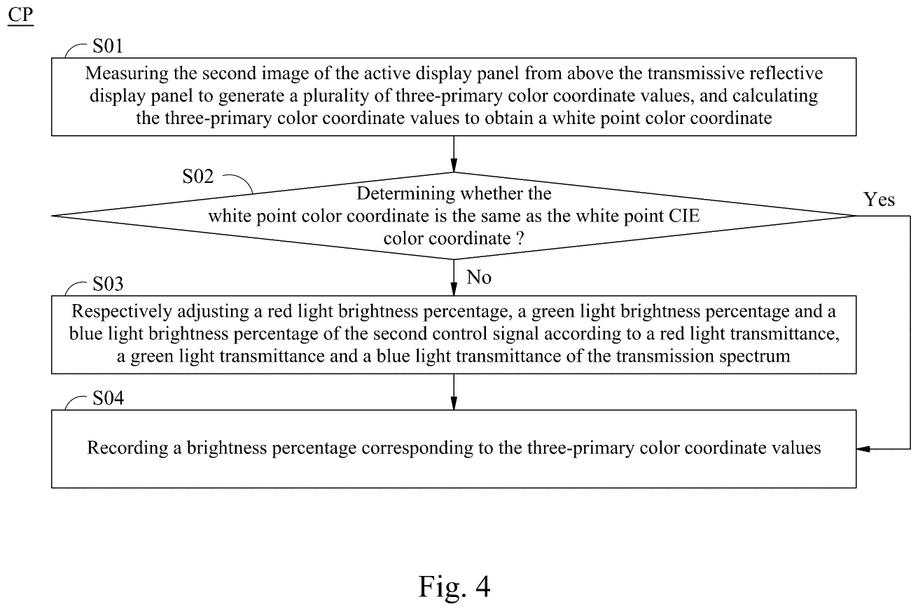

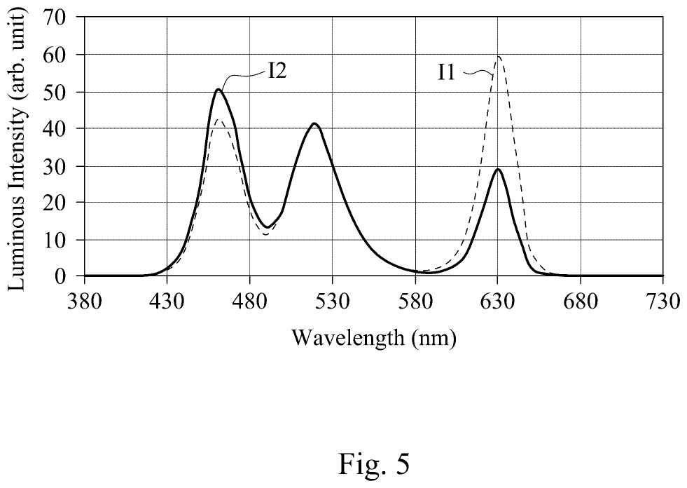

Please refer to FIGS. 1, 2, 3, 4 and 5. FIG. 2 shows a cross-sectional view of the transflective display panel of the composite display controlling system in FIG. 1. FIG. 3 shows a schematic view of a transmission spectrum of a first adhesive layer and a second adhesive layer of the transflective display panel in FIG. 1. FIG. 4 shows a flow chart of executing a white point calibration procedure in a composite display controlling method by the composite display controlling system of FIG. 1. FIG. 5 shows a comparison schematic view of two luminous intensities of the active display panel in FIG. 1 before and after adjustment.

In FIG. 2, the transflective display panel 110 can include a first display module 111, a second display module 112 and a third display module 113. The first display module 111 is configured to generate a first color light. The second display module 112 is stacked below the first display module 111 and configured to generate a second color light. The third display module 113 is stacked below the second display module 112 and configured to generate a third color light. The first color light, the second color light and the third color light are different from each other. In some embodiments, the transflective display panel 110 can be, but is not limited to a cholesteric liquid crystal display panel, that is, a display panel in cholesteric liquid crystal display (ChLCD). The first display module 111, the second display module 112 and the third display module 113 can respectively be a blue cholesteric liquid crystal module, a green cholesteric liquid crystal module and a red cholesteric liquid crystal module, and the first color light, the second color light and the third color light can respectively be blue light, green light and red light, but the present disclosure is not limited thereto.

In addition, the transflective display panel 110 further includes a first adhesive layer AL1 and a second adhesive layer AL2. The first adhesive layer AL1 is disposed between the first display module 111 and the second display module 112, and configured to absorb the light having the same color as the first color light (e.g., blue light). The second adhesive layer AL2 is disposed between the second display module 112 and the third display module 113, and configured to absorb another light having the same color as the second color light (e.g., green light). In some embodiments, the first adhesive layer AL1 can be, but is not limited to a yellow optical adhesive layer, and mainly configured to filter out the blue stray light that is not reflected by the blue cholesteric liquid crystal module, so that the blue stray light cannot penetrate downward to the lower layer. The second adhesive layer AL2 can be, but is not limited to a red optical adhesive layer, and mainly configured to filter out the green stray light that is not reflected by the green cholesteric liquid crystal module, so that the green stray light cannot penetrate downward to the lower layer. It should be noted that, as shown in FIG. 3, the transmission spectrum 342 of the transflective display panel 110 is determined by a transmittance of the first adhesive layer AL1 and a transmittance of the second adhesive layer AL2, and the transmission spectrum 342 is pre-stored in the storage unit 340. The first adhesive layer AL1 has the transmittance of only 20% in the blue light wavelength range (450 nm˜470 nm). The second adhesive layer AL2 has the transmittance of only 30% in the green light wavelength range (500 nm˜570 nm). In order to prevent the first adhesive layer AL1 and the second adhesive layer AL2 from filtering out part of the light in the second image of the active display panel 120 and causing color deviation, the composite display controlling system 10 executes a white point calibration procedure CP in the composite display controlling method to calibrate the luminous intensity of the active display panel 120 when the composite display device 100 operates in the transmission mode, thereby solving the problem of color shift.

As shown in FIGS. 1 to 5, the composite display controlling system 10 can further include a color measuring device 500. The storage unit 340 can further store a white point CIE color coordinate 343, and the white point CIE color coordinate 343 can be, but it is not limited to the white point color coordinate in CIE standard illuminant D65. The color measuring device 500 is electrically connected to the local controlling module 300. The composite display controlling system 10 is configured to implement the white point calibration procedure CP in the composite display controlling method, and the white point calibration procedure CP includes the following Steps S01, S02, S03, S04.

Step S01: measuring the second image of the active display panel 120 from above the transmissive reflective display panel 110 to generate a plurality of three-primary color (RGB) coordinate values, and calculating the three-primary color coordinate values to obtain a white point color coordinate 510 by the color measuring device 500. Step S02: receiving the white point color coordinate 510 from the color measuring device 500 and determining whether the white point color coordinate 510 is the same as the white point CIE color coordinate 343 to generate a white point determination result by the local controlling module 300. In response to determine that the white point determination result is “No”, executing Step S03. Step S03: respectively adjusting a red light brightness percentage, a green light brightness percentage and a blue light brightness percentage of the second control signal 321 according to a red light transmittance, a green light transmittance and a blue light transmittance of the transmission spectrum 342 by the local controlling module 300. In response to determine that the white point determination result is “Yes”, executing Step S04. Step S04: recording a brightness percentage corresponding to the three-primary color coordinate values in the second control signal 321 by the local controlling module 300.

In some embodiments, the red light transmittance is inversely proportional to the red light brightness percentage, the green light transmittance is inversely proportional to the green light brightness percentage, and the blue light transmittance is inversely proportional to the blue light brightness percentage. In Step S03, the local controlling module 300 adjusts the luminous intensity of the active display panel 120 based on the transmittances of the first adhesive layer AL1 and the second adhesive layer AL2, and the luminous intensity I1 before adjustment and the luminous intensity I2 after adjustment of the active display panel 120 are shown in FIG. 5. In detail, the transmittance of the first adhesive layer AL1 in the blue light wavelength range is very low, but the transmittance of the second adhesive layer AL2 is higher, so the local controlling module 300 increases the blue light brightness percentage of the second control signal 321. In the green light wavelength range, the transmittance of the first adhesive layer AL1 is higher, but the transmittance of the second adhesive layer AL2 is lower, so the local control ling module 300 can maintain or increase the green brightness percentage of the second control signal 321. In the red light wavelength range, the transmittance of the first adhesive layer AL1 and the second adhesive layer AL2 are both high transmittance, so the local controlling module 300 reduces the red light brightness percentage of the second control signal 321. After Step S03 is completed, Step S04 is executed to record the adjusted brightness percentage corresponding to the three-primary color coordinate values in the second control signal 321 (i.e., recording the adjusted red light brightness percentage, the adjusted green light brightness percentage and the adjusted blue light brightness percentage in the second control signal 321). Thus, the composite display controlling system 10 can utilize the white point calibration procedure CP to calibrate the luminous intensity of the active display panel 120, so that the second image still has high saturation after passing through the transflective display panel 110 without the color shift problem.

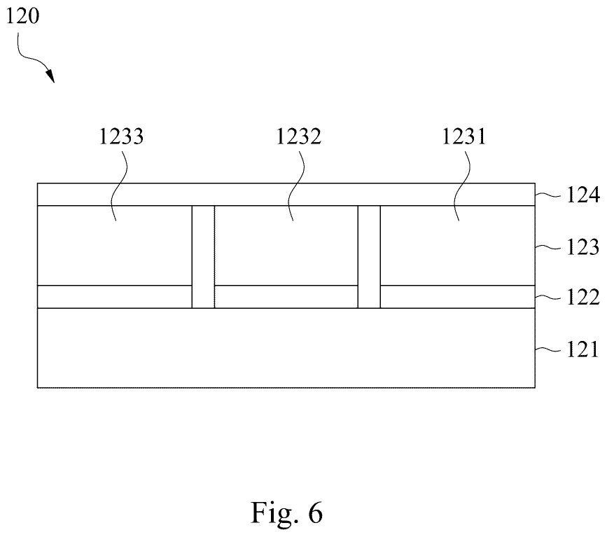

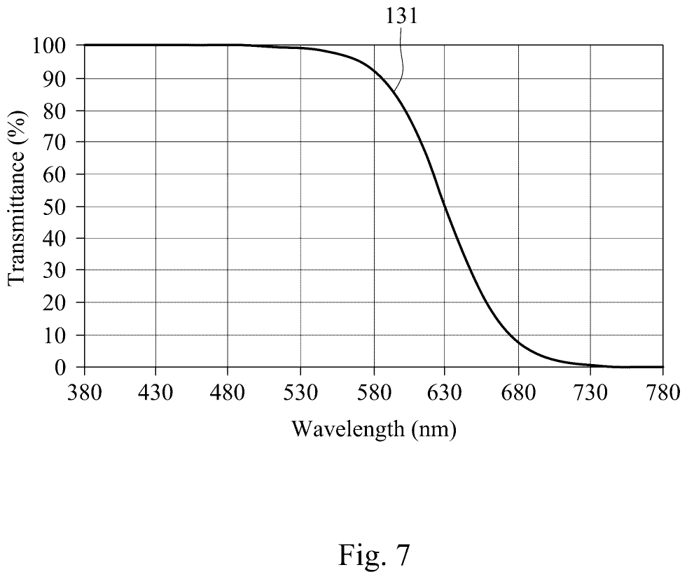

Please refer to FIGS. 1, 6 and 7. FIG. 6 shows a cross-sectional view of the active display panel of the composite display controlling system in FIG. 1. FIG. 7 shows a schematic view of a transmission spectrum of a color optical adhesive layer of the composite display device in FIG. 1. It should be noted that the active display panel 120 can include a plurality of pixels (not shown), and FIG. 6 is the cross-sectional view of the active display panel 120 corresponding to any one of the pixels. As shown in FIG. 6, the active display panel 120 can include a substrate 121, an electrode layer 122, a light emitting diode layer 123 and a protective film 124. The electrode layer 122 is disposed on the top of the substrate 121. The light emitting diode layer 123 is disposed on the top of the electrode layer 122, and includes a first light emitting element 1231, a second light emitting element 1232 and a third light emitting element 1233. The protective film 124 is disposed on the top of the light emitting diode layer 123. In some embodiments, the active display panel 120 can be, but is not limited to a mini light emitting diode (mini LED) display panel, a micro light emitting diode (micro LED) display panel, an organic light emitting diode (OLED) display panel or a perovskite light emitting diode (PeLED) display panel. The first light emitting element 1231, the second light emitting element 1232 and the third light emitting element 1233 can respectively be a blue light emitting diode, a green light emitting diode and a red light emitting diode, but the present disclosure is not limited thereto.

Further, a color optical adhesive layer 130 can be disposed between the transflective display panel 110 and the active display panel 120, a transmission spectrum 131 of the color optical adhesive layer 130 is shown in FIG. 7, and a shape of the transmission spectrum 131 of the color optical adhesive layer 130 is opposite to a shape of a reflection spectrum of the protective film 124. In detail, when the composite display device 100 operates in the reflective mode, the contrast of the transflective display panel 110 can be determined by the color of the protective film 124 of the active display panel 120. Compared with blue light and green light, the reflectivity of the protective film 124 for red light is higher. In order to prevent the transflective display panel 110 from displaying the first image with reddish color (i.e., having higher red light intensity), the composite display device 100 utilizes the configuration that the shape of the transmission spectrum 131 of the color optical adhesive layer 130 is opposite to the shape of the reflection spectrum of the protective film 124, so that part of the stray light passing through the transflective display panel 110 can be filtered out so as to improve the problem of higher red light reflectivity, and make the composite display device 100 having high contrast ratio. In addition, the configuration of the color optical adhesive layer 130 can also make the brightness of blue, green, and red light of the active display panel 120 tend to be consistent, thereby allowing the composite display control system 10 to more easily adjust the color to the desired color coordinates when executing the white point calibration procedure Cp.

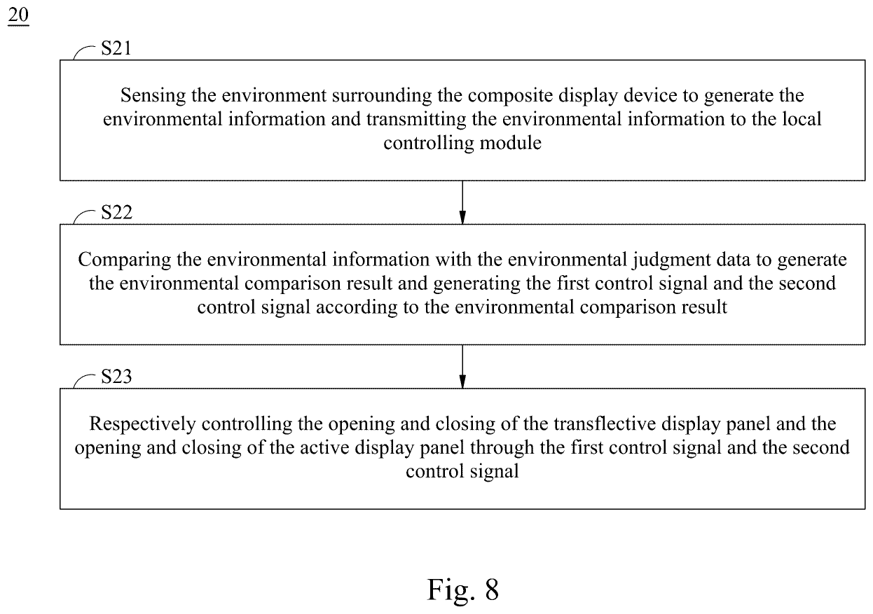

Please refer to FIGS. 1 and 8. FIG. 8 shows a flow chart of a composite display controlling method according to a second embodiment of the present disclosure. As shown in FIG. 8, the composite display controlling method 20 can be executed by the composite display controlling system 10 in FIG. 1 and configured to control the composite display device 100, and the composite display device 100 includes the transflective display panel 110 and the active display panel 120. The composite display controlling method 20 includes the following Steps S21, S22 and S23.

Step S21: sensing the environment surrounding the composite display device 200 to generate the environmental information 201 and transmitting the environmental information 201 to the local controlling module 300 by the sensing module 200. In addition, Step S21 can include transmitting the control parameter 410 and the visual content data 420 to the local controlling module 300 according to the environmental information 201 received from the local controlling module 300 so as to utilize the control parameter 410 to update the environmental judgment data 341 by the remote controlling module 400. Step S22: comparing the environmental information 201 with the environmental judgment data 341 to generate the environmental comparison result 331 and generating the first control signal 311 and the second control signal 321 according to the environmental comparison result 331 by the local controlling module 300. Step S23: respectively controlling the opening and closing of the transflective display panel 110 and the opening and closing of the active display panel 120 through the first control signal 311 and the second control signal 321 by the local controlling module 300, so that the composite display device 100 operates in the display mode.

The composite display controlling method 20 can further include the white point calibration procedure CP, which is configured to calibrate the light intensity of the active display panel 120 when the composite display device 100 operates in the transmission mode of the display mode. In detail, during the white point calibration procedure CP, the local controlling module 300 can respectively adjust the red light brightness percentage, the green light brightness percentage and the blue light brightness percentage of the second control signal 321 according to the red light transmittance, the green light transmittance and the blue light transmittance of the transmission spectrum 342 so as to calibrate the light intensity of the active display panel 120. Thus, the composite display controlling method 20 of the present disclosure can not only adjust the display mode of the composite display device 100 in real time according to the environmental information 201 to achieve the functions of intelligent energy saving and precision marketing, but also adjust the light intensity of the active display panel 120 to solve the color shift problem.

In summary, the composite display controlling system, the composite display controlling method and the composite display device of the present disclosure have the following advantages. First, the composite display controlling system and the composite display controlling method have the functions of data collection and analysis, so that the composite display device has the functions of intelligent energy saving and precision marketing. Second, the second control signal for controlling the active display panel is adjusted according to the transmission spectrum of the transflective display panel, so that the image of the composite display device has high saturation without the color shift problem. Third, by disposing the color optical adhesive layer between the transflective display panel and the active display panel to filter out stray light, the contrast of the composite display device can be improved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A composite display controlling system, comprising:
a composite display device, comprising:
a transflective display panel; and
an active display panel disposed opposite to the transflective display panel;
a sensing module configured to sense an environment surrounding the composite display device to generate an environmental information; and
a local controlling module electrically connected to the composite display device and the sensing module, and comparing the environmental information with an environmental judgment data to generate an environmental comparison result, wherein the local controlling module generates a first control signal and a second control signal according to the environmental comparison result, and respectively controls an opening and closing of the transflective display panel and an opening and closing of the active display panel through the first control signal and the second control signal, so that the composite display device operates in a display mode;
wherein the local controlling module adjusts the second control signal according to a transmission spectrum of the transflective display panel to calibrate a luminous intensity of the active display panel operating in the display mode.

2. The composite display controlling system of claim 1, further comprising:
a remote controlling module signally connected to the local controlling module, and transmitting a control parameter and a visual content data to the local controlling module according to the environmental information received from the local controlling module so as to utilize the control parameter to update the environmental judgment data;
wherein the local controlling module generates a first enable signal of the first control signal and a second enable signal of the second control signal according to the environmental comparison result, and generates a first image data of the first control signal and a second image data of the second control signal.

3. The composite display controlling system of claim 2, wherein,
the opening and closing of the transflective display panel are controlled by the first enable signal, and the transflective display panel displays a first image based on the first image data; and
the opening and closing of the active display panel are controlled by the second enable signal, and the active display panel displays a second image based on the second image data.

4. The composite display controlling system of claim 1, wherein the local controlling module comprises:
a first controlling unit configured to control the transflective display panel;
a second controlling unit configured to control the active display panel; and
a processing unit electrically connected to the first controlling unit, the second controlling unit and the sensing module, and respectively transmitting a first control command and a second control command to the first controlling unit and second controlling unit according to the environmental comparison result;
wherein the first controlling unit generates the first control signal according to the first control command, and the second controlling unit generates the second control signal according to the second control command.

5. The composite display controlling system of claim 1, wherein the sensing module comprises:
a brightness sensor configured to sense the environment surrounding the composite display device to generate a brightness value of the environmental information;
a human body sensor configured to sense the environment surrounding the composite display device to generate a human body appearance frequency of the environmental information; and
a temperature sensor configured to sense the environment surrounding the composite display device to generate a temperature value of the environmental information.

6. The composite display controlling system of claim 5, wherein,
the environmental judgment data comprises a brightness threshold, and the display mode comprises a reflection mode and a transmission mode;
in response to determine that the environmental comparison result is that the brightness value is greater than or equal to the brightness threshold, the local controlling module controls the transflective display panel to be turned on through the first control signal and controls the active display panel to be turned off through the second control signal, so that the composite display device operates in the reflection mode; and
in response to determine that the environmental comparison result is that the brightness value is less than the brightness threshold, the local controlling module controls the transflective display panel to be turned off through the first control signal and controls the active display panel to be turned on through the second control signal, so that the composite display device operates in the transmission mode.

7. The composite display controlling system of claim 5, wherein,
the environmental judgment data comprises a frequency threshold;
in response to determine that the environment comparison result is that the human body appearance frequency is greater than or equal to the frequency threshold, the local controlling module changes a first image refresh rate of the transflective display panel to a first refresh rate through the first control signal, and changes a second image refresh rate of the active display panel to the first refresh rate through the second control signal; and
in response to determine that the environment comparison result is that the human body appearance frequency is less than the frequency threshold, the local controlling module changes the first image refresh rate of the transflective display panel to a second refresh rate through the first control signal, and changes the second image refresh rate of the active display panel to the second refresh rate through the second control signal, wherein the second refresh rate is less than the first refresh rate.

8. The composite display controlling system of claim 5, wherein,
the environmental judgment data comprises a temperature threshold;
in response to determine that the environment comparison result is that the temperature value is greater than or equal to the temperature threshold, the local controlling module controls the transflective display panel to display a first image corresponding to a first visual content through the first control signal, and controls the active display panel to display a second image corresponding to the first visual content through the second control signal; and
in response to determine that the environment comparison result is that the temperature value is less than the temperature threshold, the local controlling module controls the transflective display panel to display the first image corresponding to a second visual content through the first control signal, and controls the active display panel to display the second image corresponding to the second visual content through the second control signal.

9. The composite display controlling system of claim 1, further comprising:
a color measuring device electrically connected to the local controlling module, wherein the color measuring device is configured to measure the active display panel to generate a plurality of three-primary color coordinate values, and calculates the three-primary color coordinate values to obtain a white point color coordinate;
wherein the local controlling module determines whether the white point color coordinate is the same as a white point CIE color coordinate to generate a white point determination result;
wherein in response to determine that the white point determination result is yes, the local controlling module records a brightness percentage corresponding to the three-primary color coordinate values in the second control signal;
wherein in response to determine that the white point determination result is no, the local controlling module adjusts a red light brightness percentage, a green light brightness percentage and a blue light brightness percentage of the second control signal according to a red light transmittance, a green light transmittance and a blue light transmittance of the transmission spectrum;
wherein the red light transmittance is inversely proportional to the red light brightness percentage, the green light transmittance is inversely proportional to the green light brightness percentage, and the blue light transmittance is inversely proportional to the blue light brightness percentage.

10. A composite display controlling method, which is configured to control a composite display device, wherein the composite display device comprises a transflective display panel and an active display panel, and the composite display control method comprising:
sensing an environment surrounding the composite display device to generate an environmental information by a sensing module;
comparing the environmental information with an environmental judgment data to generate an environmental comparison result and generating a first control signal and a second control signal according to the environmental comparison result by a local controlling module; and
respectively controlling an opening and closing of the transflective display panel and an opening and closing of the active display panel through the first control signal and the second control signal by the local controlling module, so that the composite display device operates in a display mode;
wherein the local controlling module adjusts the second control signal according to a transmission spectrum of the transflective display panel to calibrate a luminous intensity of the active display panel operating in the display mode.

11. The composite display controlling method of claim 10, wherein a step of sensing the environment surrounding the composite display device to generate the environmental information by the sensing module comprises:
transmitting a control parameter and a visual content data to the local controlling module according to the environmental information received from the local controlling module so as to utilize the control parameter to update the environmental judgment data by a remote controlling module;
wherein the local controlling module generates a first enable signal of the first control signal and a second enable signal of the second control signal according to the environmental comparison result, and generates a first image data of the first control signal and a second image data of the second control signal.

12. The composite display controlling method of claim 11, wherein,
the opening and closing of the transflective display panel are controlled by the first enable signal, and the transflective display panel displays a first image based on the first image data; and
the opening and closing of the active display panel are controlled by the second enable signal, and the active display panel displays a second image based on the second image data.

13. The composite display controlling method of claim 10, wherein,
the sensing module comprises a brightness sensor for sensing the environment surrounding the composite display device to generate a brightness value of the environmental information, the environmental judgment data comprises a brightness threshold, and the display mode comprises a reflection mode and a transmission mode;
in response to determine that the environmental comparison result is that the brightness value is greater than or equal to the brightness threshold, the local controlling module controls the transflective display panel to be turned on through the first control signal and controls the active display panel to be turned off through the second control signal, so that the composite display device operates in the reflection mode; and
in response to determine that the environmental comparison result is that the brightness value is less than the brightness threshold, the local controlling module controls the transflective display panel to be turned off through the first control signal and controls the active display panel to be turned on through the second control signal, so that the composite display device operates in the transmission mode.

14. The composite display controlling method of claim 10, wherein,
the sensing module comprises a human body sensor for sensing the environment surrounding the composite display device to generate a human body appearance frequency of the environmental information, and the environmental judgment data comprises a frequency threshold;
in response to determine that the environment comparison result is that the human body appearance frequency is greater than or equal to the frequency threshold, the local controlling module changes a first image refresh rate of the transflective display panel to a first refresh rate through the first control signal, and changes a second image refresh rate of the active display panel to the first refresh rate through the second control signal; and
in response to determine that the environment comparison result is that the human body appearance frequency is less than the frequency threshold, the local controlling module changes the first image refresh rate of the transflective display panel to a second refresh rate through the first control signal, and changes the second image refresh rate of the active display panel to the second refresh rate through the second control signal, wherein the second refresh rate is less than the first refresh rate.

15. The composite display controlling method of claim 10, wherein,
the sensing module comprises a temperature sensor for sensing the environment surrounding the composite display device to generate a temperature value of the environmental information, and the environmental judgment data comprises a temperature threshold;
in response to determine that the environment comparison result is that the temperature value is greater than or equal to the temperature threshold, the local controlling module controls the transflective display panel to display a first image corresponding to a first visual content through the first control signal, and controls the active display panel to display a second image corresponding to the first visual content through the second control signal; and
in response to determine that the environment comparison result is that the temperature value is less than the temperature threshold, the local controlling module controls the transflective display panel to display the first image corresponding to a second visual content through the first control signal, and controls the active display panel to display the second image corresponding to the second visual content through the second control signal.

16. The composite display controlling method of claim 10, further comprising:
measuring the active display panel to generate a plurality of three-primary color coordinate values, and calculating the three-primary color coordinate values to obtain a white point color coordinate by a color measuring device; and
determining whether the white point color coordinate is the same as a white point CIE color coordinate to generate a white point determination result by the local controlling module;
wherein in response to determine that the white point determination result is yes, the local controlling module records a brightness percentage corresponding to the three-primary color coordinate values in the second control signal;
wherein in response to determine that the white point determination result is no, the local controlling module adjusts a red light brightness percentage, a green light brightness percentage and a blue light brightness percentage of the second control signal according to a red light transmittance, a green light transmittance and a blue light transmittance of the transmission spectrum;
wherein the red light transmittance is inversely proportional to the red light brightness percentage, the green light transmittance is inversely proportional to the green light brightness percentage, and the blue light transmittance is inversely proportional to the blue light brightness percentage.

17. A composite display device, which is controlled by a local controlling module, and the composite display device comprising:
a transflective display panel receiving a first control signal from the local controlling module, wherein an opening and closing of the transflective display panel is controlled by the first control signal; and
an active display panel disposed opposite to the transflective display panel and receiving a second control signal from the local controlling module, wherein an opening and closing of the active display panel is controlled by the second control signal;
wherein the composite display device operates in a display mode, and the second control signal is adjusted according to a transmission spectrum of the transflective display panel to calibrate a luminous intensity of the active display panel operating in the display mode.

18. The composite display device of claim 17, wherein the transflective display panel comprises:
a first display module configured to generate a first color light;
a second display module stacked below the first display module and configured to generate a second color light; and
a third display module stacked below the second display module and configured to generate a third color light;
wherein the first color light, the second color light and the third color light are different from each other.

19. The composite display device of claim 18, wherein the transflective display panel further comprises:
a first adhesive layer disposed between the first display module and the second display module, and configured to absorb a light having the same color as the first color light; and
a second adhesive layer disposed between the second display module and the third display module, and configured to absorb another light having the same color as the second color light;
wherein the transmission spectrum is determined by a transmittance of the first adhesive layer and a transmittance of the second adhesive layer.

20. The composite display device of claim 17, wherein the active display panel comprises:
a substrate;
an electrode layer disposed on the substrate;
a light emitting diode layer disposed on the electrode layer; and
a protective film disposed on the light emitting diode layer.

21. The composite display device of claim 20, wherein a color optical adhesive layer is disposed between the transflective display panel and the active display panel, and a shape of a transmission spectrum of the color optical adhesive layer is opposite to a shape of a reflection spectrum of the protective film.
